(19) United States
(12) Patent Application Publication
(10) Pub. No.: US 2020/0302046 A1
(43) Pub. Date: Sep. 24, 2020

(54) INFORMATION PROCESSING APPARATUS AND COMPUTER PROGRAM PRODUCT

(71) Applicant: FUJITSU CLIENT COMPUTING LIMITED, Kanagawa (JP)

(72) Inventor: Hideyuki Shinmura, Kawasaki (JP)

(73) Assignee: FUJITSU CLIENT COMPUTING LIMITED, Kanagawa (JP)

(21) Appl. No.: 16/775,516

(22) Filed: Jan. 29, 2020

(30) Foreign Application Priority Data
Mar. 19, 2019 (JP) 2019-051193

(51) Int. Cl. G06F 21/34; G06F 21/45; G06F 21/44; G06F 21/57

(52) U.S. Cl. CPC G06F 21/34; G06F 21/572; G06F 21/44; G06F 21/45

(57) ABSTRACT

An information processing apparatus includes: a memory; and a hardware processor coupled to the memory. The hardware processor detects a state of one or more given terminals; determines whether a given release code is recorded in an external connection device; and releases a basic input output system (BIOS) password when the state of the given terminals is a given transition instruction state and the hardware processor determines that the given release code is recorded in the external connection device.

### CROSS-REFERENCE TO RELATED APPLICATIONS

This application is based upon and claims the benefit of priority from Japanese Patent Application No. 2019-051193, filed Mar. 19, 2019, the entire contents of which are incorporated herein by reference.

### FIELD

Embodiments described herein relate generally to an information processing apparatus and a computer program product.

### BACKGROUND

When a personal computer is broken down at a user's place, the user generally requests a maker serving as the selling source to repair the personal computer.

In such a case, when an activation password (a basic input output system (BIOS) password) has been set in the BIOS of the personal computer, the password cannot be released. As a result, the whole substrate is often replaced, thereby increasing a repair workload and a repair cost.

For the above reason, a notification is described in a manual to the user such that the password should be released when requesting the personal computer to repair, for example. However, in some cases, the user is not aware of the notification in the manual and requests to repair the personal computer without releasing the BIOS password.

In this case, the password can be released by using software such as a password release algorithm which is not open to the user. Such a technique of releasing the password thoroughly in a software manner is applicable for any personal computer in the case where the release algorithm is analyzed and identified, so that a problem may arise.

### SUMMARY

An information processing apparatus according to a first aspect of the present disclosure includes a memory and a hardware processor coupled to the memory. The hardware processor is configured to: detect a state of one or more given terminals; determine whether a given release code is recorded in an external connection device; and release a basic input output system (BIOS) password when the state of the given terminals 1 is a given transition instruction state and it is determined that the given release code is recorded in the external connection device.

A computer program product according to a second aspect of the present disclosure includes programmed instructions embodied in and stored on a non-transitory computer readable medium, the programmed instructions being executed by a computer as an information processing apparatus connectable to an external connection device. The programmed instructions cause the computer to: detect a state of one or more one or more given terminals; determine whether a given release code is recorded in the external connection device; and release a basic input output system (BIOS) password when the state of the given terminals is a given transition instruction state and it is determined that the given release code is recorded in the external connection device.

### BRIEF DESCRIPTION OF THE DRAWINGS

FIG. 1 is a block diagram illustrating a hardware configuration of an information processing apparatus according to a first embodiment;

FIG. 2 is a functional block diagram illustrating a software configuration of BIOS of the information processing apparatus according the first embodiment;

FIG. 3 is a diagram for explaining an exemplary flowchart of processing at starting the information processing apparatus according the first embodiment; and

FIG. 4 is a diagram for explaining an exemplary flowchart of processing at starting the information processing apparatus in a second embodiment.

### DETAILED DESCRIPTION

The above-mentioned aspects of the present disclosure are capable of providing a password release technique that makes it difficult to analyze a procedure of releasing a BIOS password and that allows releasing the BIOS password in a simple procedure.

The following describes embodiments according to an information processing apparatus and a computer program product in detail with reference to the accompanying drawings. The embodiments described below are only examples and do not intend to exclude applications of various modifications and techniques that are not described in the embodiments. The embodiments can be implemented by being variously modified without departing from the spirits of the invention. The respective drawings can include not only the constituent elements illustrated in the drawings but also other functions.

### 1. First Embodiment

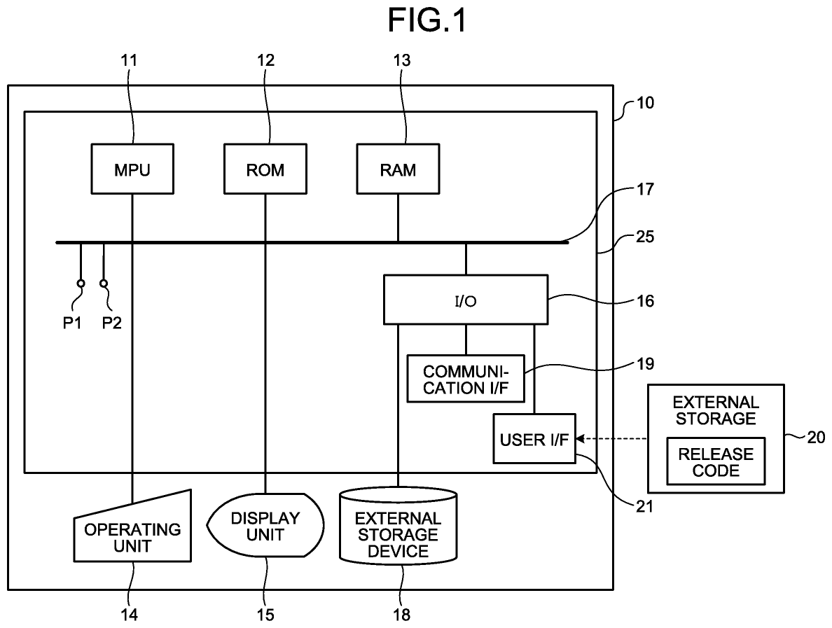

FIG. 1 is a block diagram illustrating a hardware configuration of an information processing apparatus according to the first embodiment. An information processing apparatus 10 is structured as what is called a notebook personal computer. The information processing apparatus 10 includes: a microprocessor unit (MPU) 11 (a hardware processor) that controls the whole of the information processing apparatus 10; a read only memory (ROM) 12 that stores various types of data in a non-volatile manner, a random access memory (RAM) 13 that is used as a work area and stores various types of data in a volatile manner; an operating unit 14 that is structured as a keyboard, a touch pad, or the like; a display unit 15 that is structured as a liquid crystal display; an input-output (I/O) unit 16 that interfaces with various devices; and an internal bus 17 that connects these hardware elements in a communicable manner.

In the first embodiment, the notebook personal computer is exemplarily described. The information processing apparatus is not limited to the notebook personal computer. The embodiment may be applicable for various information processing apparatuses such as a stationary personal computer, a large-sized computer, and a portable tablet device.

The information processing apparatus 10 also includes: an external storage device 18 that is connected to the input-output unit 16 and is structured as a hard disk drive or a solid state drive (SSD); a communication interface (I/F) 19 that is connected to the input-output unit 16 and performs interface operation when communication is performed via a communication network (not illustrated) such as the Internet; an external storage 20 that is connected to the input-output unit 16 and is implemented by a universal serial bus (USB) memory, a memory card, or the like; and a user interface (I/F) 21 to which external input-output equipment such as a USB mouse can be connected.

The MPU 11, the ROM 12, the RAM 13, and the input-output unit 16 are arranged on a main board 25.

The internal bus 17 is formed on the main board 25 and is provided with a pair of pin terminals P1 and P2. The pin terminals P1 and P2 are used for instructing, by a repair worker or the like, transition to a basic input output system (BIOS) password release mode by handling the pin terminals P1 and P2 to be in a short-circuit state.

A BIOS is stored in the ROM 12. When power supply to the information processing apparatus 10 starts, the BIOS stored in the ROM 12 is read into the MPU 11. The MPU 11 performs various types of processing to initialize the information processing apparatus 10. The ROM 12, in which the BIOS is written, only needs to be a non-volatile recording medium. The ROM 12 may be writable for upgrading the BIOS.

The BIOS in the embodiment allows setting of a BIOS password. When the BIOS password has been set to the BIOS in the embodiment, only the user who knows the BIOS password can use the information processing apparatus 10, in general. In some cases, the BIOS password remains being set even when the information processing apparatus 10 is broken down and repair is requested to the manufacturer.

The BIOS in the embodiment makes it possible to start the information processing apparatus 10 when a rightful user (for example, the manufacturer) performs repair and maintenance of the information processing apparatus 10 even if he/she does not know the BIOS password.

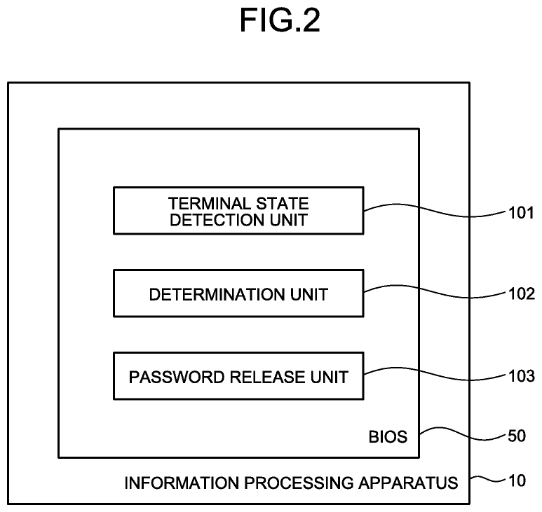

FIG. 2 is a functional block diagram illustrating a software configuration of the BIOS in the information processing apparatus 10 in the embodiment. In FIG. 2, the software configuration is illustrated, which is implemented by that the MPU 11 reads the BIOS 50. As illustrated in FIG. 2, the BIOS 50 includes a terminal state detection unit 101, a determination unit 102, and a password release unit 103, besides various configurations for initializing the information processing apparatus 10. The BIOS 50 in the embodiment functions as a BIOS password release processing program.

The terminal state detection unit 101 detects a state of one or more given terminals. The terminal state detection unit 101 in the embodiment detects, as the terminal state, whether the pair of the pin terminals P1 and P2 are short-circuited.

The determination unit 102 determines whether a given release code is recorded in the external storage 20 (an example of the external connection device). The determination unit 102 in the embodiment determines whether the external storage 20 is connected. The determination unit 102 in the embodiment determines whether a name of a file stored in the external storage 20 matches file name information stored by the BIOS 50 when determining that the external storage 20 is connected. When the name of the file stored in the external storage 20 matches the file name information stored by the BIOS 50, the determination unit 102 determines that the given release code is recorded.

The password release unit 103 releases the BIOS password when the state of the given terminals is a given transition instruction state and it is determined that the given release code is recorded in the external connection device. In the embodiment, a state where the pair of the pin terminals P1 and P2 are short-circuited is referred to as the given transition instruction state. When the BIOS password is released by the password release unit 103, the BIOS 50 is able to proceed with processing until the user can operate the information processing apparatus 10 without inputting the BIOS password.

The configuration described above disables the BIOS password to be released unless the given terminals is in the given transition instruction state and the given release code is detected from the external storage 20. Thus, it is possible to prevent the BIOS password from being released by an uncertain person who analyzes an algorism for releasing the password in a software manner.

Furthermore, even when the BIOS password has been set before repair of the information processing apparatus 10, the configuration described above is capable of releasing the BIOS password in a simple procedure to allow the information processing apparatus 10 to start. Thus, it is possible to smoothly find and repair a defective portion.

The following describes the BIOS password release processing.

Prior to release of the BIOS password, a repair worker opens a housing of the information processing apparatus 10 to expose the pin terminals P1 and P2, and handles the pin terminals P1 and P2 to be in a short-circuit state.

The repair worker connects, to the user interface 21, the external storage 20 in which the given release code has been recorded.

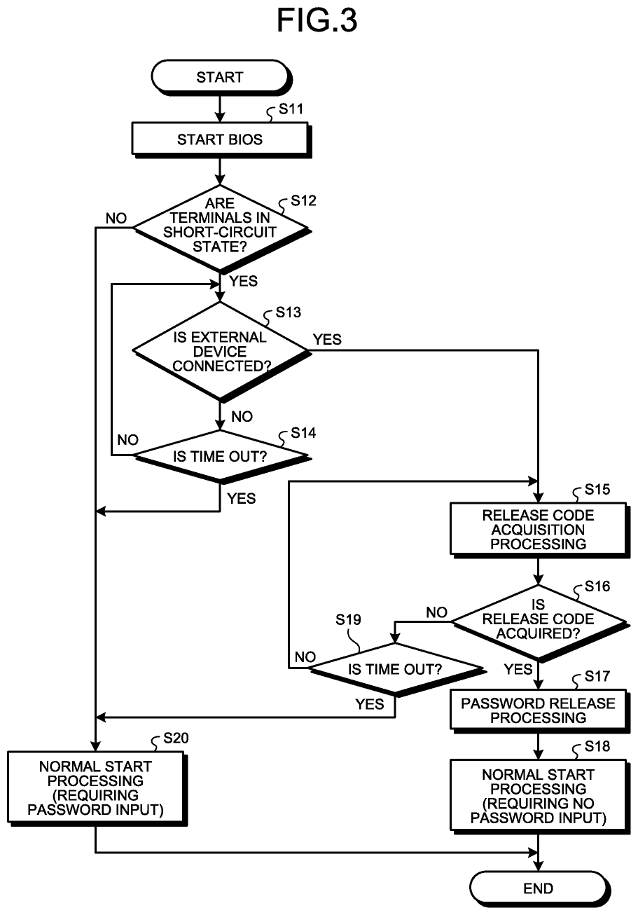

FIG. 3 is a diagram for explaining an exemplary flowchart of processing at starting the information processing apparatus 10 in the first embodiment.

When the power supply to the information processing apparatus 10 starts in the state described above, the BIOS starts (step S11).

The terminal state detection unit 101 of the BIOS 50 detects whether the pin terminals P1 and P2 are short-circuited (step S12).

When it is detected at step S12 that the pin terminals P1 and P2 are not short-circuited (No at step S12), the BIOS 50 proceeds to a normal start processing and requests the user to input the BIOS password (step S20).

When it is detected at step S12 that the pin terminals P1 and P2 are short-circuited (Yes at step S12), this is a state where transition to the BIOS password release mode is instructed. In this case, the determination unit 102 determines whether the external storage 20 serving as the external apparatus is connected (step S13).

When it is determined at step S13 that the external storage 20 serving as the external apparatus is not connected (No at step S13), the determination unit 102 displays indication for urging the connection of the external apparatus and determines whether time is out (step S14).

When it is determined at step S14 that time is not out (No at step S14), the BIOS 50 becomes a standby state to wait for the connection of the external apparatus and proceeds to the processing at step S13 again to repeat the processing described above.

When it is determined at step S14 that time is out (Yes at step S14), the BIOS 50 proceeds to the normal start processing and requests the user to input the BIOS password (step S20).

When it is determined at step S13 that the external storage 20 serving as the external apparatus is connected (Yes at step S13), the determination unit 102 performs processing to acquire the given release code from the connected external storage 20 (step S15).

Examples of the release code include a given file name and specific data included in the given file. Examples of the processing to acquire the given release code include a process of searching for a file having the given file name or a process of reading out the specific data by opening the given file.

Next, the determination unit 102 determines whether the given release code is acquired (step S16). The determination unit 102 determines that the given release code is acquired when, for example, the file having a file name matching the file name information stored by the BIOS 50 is detected from the external storage 20 (which is an example of the external connection device). For another example, when the data matching specific stored information stored by the BIOS 50 is included in the given file in the external storage 20, the determination unit 102 determines that the given release code is acquired. The file name information and the specific stored information may represent any character string. The specific stored information may be a binary code, for example.

When it is determined at step S16 that the given release code is not acquired (No at step S16), the determination unit 102 determines whether time is out (step S19).

When it is determined at step S19 that time is not out (No at step S19), the BIOS 50 becomes a standby state to wait for the acquisition of the given release code from the external storage 20 and proceeds to the processing at step S15 again to repeat the processing described above.

When it is determined at step S19 that time is out (Yes at step S19), the BIOS 50 proceeds to the normal start processing and requests the user to input the BIOS password (step S20).

When it is determined at step S16 that the given release code is acquired (Yes at step S16), the password release unit 103 performs processing to release the BIOS password (step S17). After that, the BIOS 50 proceeds to the normal start processing requiring no password input and starts without requesting the user to input the BIOS password (step S18).

As described above, according to the first embodiment, it is prohibited to release the BIOS password unless the given release code (such as the given file name and the specific data in the given file) is detected from the external storage 20. Thus, it is possible to prevent the BIOS password from being released by an uncertain person who analyzes an algorism for releasing the password in a software manner.

Furthermore, even when the BIOS password has been set before repair of the information processing apparatus 10, the configuration described above is able to release the BIOS password and allow the information processing apparatus 10 to start. Thus, it is possible to smoothly find and repair a defective portion of the information processing apparatus 10.

### 2. Second Embodiment

In the foregoing first embodiment, the BIOS password is released when the given terminals are in a short-circuit state and a given release code is stored in the external connection device. In the second embodiment, the BIOS password is released when a given key on a keyboard or the like is pressed in addition to satisfying the conditions required in the first embodiment.

The configuration of the information processing apparatus 10 in the second embodiment is the same as that of the information processing apparatus 10 in the first embodiment illustrated in FIGS. 1 and 2. Description is, thus, made with reference to FIGS. 1 and 2. In the second embodiment, a keyboard is connected or is connectable to the operating unit 14.

In the same manner as the foregoing first embodiment, prior to release of the BIOS password, the repair worker opens the housing of the information processing apparatus 10 to exposes the pin terminals P1 and P2. Then, the repair worker handles the pin terminals P1 and P2 to be in a short-circuit state and connects the external storage 20, in which the given release code has been recorded, to the user interface 21.

The determination unit 102 in the second embodiment determines whether a given key on the keyboard as an example of the operating unit 14 is pressed in addition to the processing in the first embodiment. The given key on the keyboard may be optionally set in advance. For example, the given key may be a function key or a space key. The timing of determining whether the given key is pressed is a given timing at starting of the BIOS 50, for example. The timing may be in a time period until the BIOS 50 proceeds to the normal processing.

The password release unit 103 in the embodiment releases the BIOS password when three conditions are satisfied. The conditions are that: the terminal state is the given transition instruction state; it is determined that the given release code is recorded in the external connection device; and the given key on the keyboard is pressed.

The following describes the BIOS password release processing in the second embodiment.

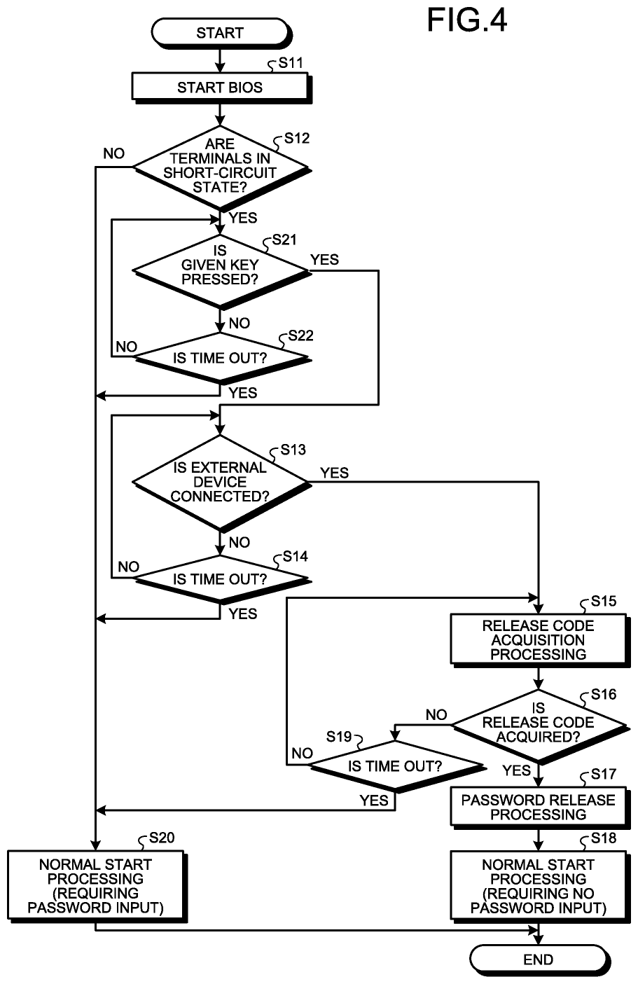

FIG. 4 is a diagram for explaining an exemplary flowchart of processing at starting the information processing apparatus 10 in the second embodiment.

In the state described above, the BIOS 50 starts when power is supplied to the information processing apparatus 10 (step S11).

The terminal state detection unit 101 of the BIOS 50 detects whether the pin terminals P1 and P2 are short-circuited (step S12).

When it is detected at step S12 that the pin terminals P1 and P2 are not short-circuited (No at step S12), the BIOS 50 proceeds to a normal start processing and requests the user to input the BIOS password (step S20).

When it is detected at step S12 that the pin terminals P1 and P2 are short-circuited (Yes at step S12), this is a state where transition to the BIOS password release mode is instructed. In this case, the determination unit 102 determines whether the given key of the operating unit 14 is pressed by the repair worker (step S21).

When it is determined at step S21 that the given key of the operating unit 14 is not pressed by the repair worker (No at step S21), the determination unit 102 further determines whether time is out (step S22).

When it is determined at step S22 that time is not out (No at step S22), the BIOS 50 becomes a standby state to wait for the press of the given key and proceeds to the processing at step S21 again to repeat the processing described above.

When it is determined at step S21 that the given key of the operating unit 14 is pressed by the repair worker (Yes at step S21), the determination unit 102 further determines whether the external storage 20 serving as the external apparatus is connected (step S13).

When it is determined at step S13 that the external storage 20 serving as the external apparatus is not connected (No at step S13), the determination unit 102 displays indication for urging the connection of the external apparatus and determines whether time is out (step S14).

When it is determined at step S14 that time is not out (No at step S14), the BIOS 50 becomes a standby state to wait for the connection of the external apparatus and proceeds to the processing at step S13 again to repeat the processing described above.

When it is determined at step S14 that time is out (Yes at step S14), the BIOS 50 proceeds to the normal start processing and requests the user to input the BIOS password (step S20).

When it is determined at step S13 that the external storage 20 serving as the external apparatus is connected (Yes at step S13), the determination unit 102 performs processing to acquire the given release code from the connected external storage 20 (step S15).

Examples of the release code include a given file name and specific data included in the given file. Examples of the processing to acquire the given release code include a process of searching for a file having the given file name or a process of reading out the specific data by opening the given file.

Next, the determination unit 102 determines whether the given release code is acquired (step S16). For example, when the file having a file name matching the file name information stored by the BIOS 50 is detected from the external storage 20 (the example of the external connection device), the determination unit 102 determines that the given release code is acquired.

When it is determined at step S16 that the given release code is not acquired (No at step S16), the determination unit 102 determines whether time is out (step S19).

When it is determined at step S19 that time is not out (No at step S19), the BIOS 50 becomes a standby state for waiting the acquisition of the given release code from the external storage 20 and proceeds to the processing at step S15 again to repeat the processing described above.

When it is determined at step S19 that time is out (Yes at step S19), the BIOS 50 proceeds to the normal start processing and requests the user to input the BIOS password (step S20).

When it is determined at step S16 that the given release code is acquired (Yes at step S16), the password release unit 103 performs processing to release the BIOS password (step S17). After that, the BIOS 50 proceeds to the normal start processing requiring no password input and starts without requesting the user to input the BIOS password (step S18).

As described above, according to the second embodiment, it is prohibited to release the BIOS password when the given key is not pressed in addition to the conditions required in the first embodiment. Thus, it is possible to prevent the BIOS password from being released by an uncertain person who analyzes an algorism for releasing the password in a software manner, thereby enhancing security. Furthermore, even when the BIOS password has been set before repair of the information processing apparatus 10, the configuration described above is able to release the BIOS password though a simple procedure and allow the information processing apparatus to start. Thus, it is possible to smoothly find and repair a defective portion of the information processing apparatus 10.

The procedure to proceed to the BIOS password release processing is simple, similar to that in the first embodiment. Thus, even when the BIOS password has been set before the repair, the configuration described above is able to release the BIOS password and allow the information processing apparatus to start, thereby making it possible to smoothly find and repair a defective portion of the information processing apparatus 10.

### 3. Modifications of Embodiments

In the embodiments described above, the release code is intended to represent a single file name or a single piece of specific data included in the given file. Alternatively, the release code may include a plurality of the file names or plural pieces of the specific data, or may be formed by a combination thereof.

In the embodiments described above, the BIOS 50 shifts to the password release mode when the state of the given pin terminals P1 and P2 as the given terminals is a short-circuit state. Alternatively, the BIOS 50 may shift to the password release mode when the terminals, which are usually in a short-circuit state, shift to an open state.

Furthermore, the BIOS 50 may shift to the password release mode when the terminal state of a plurality of sets of the terminals becomes a given state.

In the embodiments described above, the given pin terminals P1 and P2 are used. Alternatively, a setting switch, such as a dual in-line package (DIP) switch (or part of switches included in the DIP switch) or a rotary DIP switch, may be used. In this case, the BIOS 50 shifts to the password release mode when the setting switch is set in a given state.

The present disclosure allows person skilled in the art to implement the embodiments and perform manufacturing according to the embodiments.

### 4. Other Aspects of Embodiments

The following describes other aspects of the embodiments described above.

4.1 First Other Aspect

The terminal state detection unit 101 detects the terminal state at a time when the power supply to the information processing apparatus 10 starts.

The configuration described above prevents a state that allows the transition to the BIOS password release state from continuing for long time after the power supply starts, thereby making it possible to maintain the security.

4.2 Second Other Aspect

The release code is a given file name or given data included in the given file.

The configuration described above makes easy to check the release code, thereby preventing the processing to release the BIOS password from taking a long time more than necessary.

4.3 Third Other Aspect

A BIOS password release processing program that functions in the BIOS 50 implements the following functions, for example.

The BIOS password release processing program includes programmed instructions embodied in and stored on a non-transitory computer readable medium. The programmed instructions are executed by a computer as the information processing apparatus 10 that has one or more terminals for instructing transition to a BIOS password release mode and is connectable to an external connection device (20). The programmed instructions cause the computer to: detect a state of one or more given terminals; determine whether a given release code is recorded in the external connection device; and release a BIOS password when the state of the given terminals is a given transition instruction state and it is determined that the given release code is recorded in the external connection device.

According to the configuration described above, it is prohibited to release the BIOS password unless the state of the given terminals is the given transition instruction state and the given release code is detected from the external storage 20 (the example of the external connection device), thereby preventing the BIOS password from being released by an uncertain person who analyzes an algorism for releasing the password in a software manner.

Furthermore, even when the BIOS password has been set before the repair, the configuration described above is able to release the BIOS password by a simple procedure and allow the information processing apparatus to start, thereby making it possible to smoothly find and repair a defective portion of the information processing apparatus 10.

What is claimed is:

1. An information processing apparatus comprising:
a memory; and
a hardware processor that is coupled to the memory and that:
detects a state of one or more given terminals;
determines whether a given release code is recorded in an external connection device; and
releases a basic input output system (BIOS) password when the state of the given terminals is a given transition instruction state and the hardware processor determines that the given release code is recorded in the external connection device.

2. The information processing apparatus according to claim 1, wherein
the information processing apparatus is connected to a keyboard or is connectable to a keyboard, and
the hardware processor carries out the release of the BIOS password when
the state of the given terminals is the given transition instruction state,
it is determined that the given release code is recorded in the external connection device, and
a given key on the keyboard is pressed in a given timing.

3. The information processing apparatus according to claim 1, wherein the hardware processor carries out the detection of the state of the given terminals at a time when power supply to the information processing apparatus starts.

4. The information processing apparatus according to claim 1, wherein the release code is provided as a given file name or given data included in a given file.

5. A non-transitory computer readable medium comprising programmed instructions, the programmed instructions being executed by a computer as an information processing apparatus having a given terminal and being connectable to an external connection device, the programmed instructions causing the computer to:
detect a state of one or more given terminals;
determine whether a given release code is recorded in the external connection device; and
release a basic input output system (BIOS) password when the state of the given terminals is a given transition instruction state and it is determined that the given release code is recorded in the external connection device.
